(19) United States
(12) Patent Application Publication
(10) Pub. No.: US 2025/0373745 A1
(43) Pub. Date: Dec. 4, 2025

(54) IMAGE FORMING APPARATUS, CONTROL METHOD THEREOF, AND STORAGE MEDIUM

(71) Applicant: CANON KABUSHIKI KAISHA, Tokyo (JP)

(72) Inventor: TAKAHIRO OKUBO, Kanagawa (JP)

(21) Appl. No.: 19/225,488

(22) Filed: Jun. 2, 2025

(30) Foreign Application Priority Data
Jun. 4, 2024 (JP) 2024-090923

(51) Int. Cl. H04N 1/00

(52) U.S. Cl. CPC H04N 1/00904; H04N 1/00405; H04N 2201/0094

(57) ABSTRACT

The present disclosure is directed to an image forming apparatus comprising: one or more memory devices that store a set of instructions; and one or more processors that execute the set of instructions to: receive a period from a user; obtain, for each of a plurality of functions included in the image forming apparatus, power consumed to provide the function in the received period; and output the obtained power for each of the functions.

### BACKGROUND

### Field of the Technology

The present disclosure relates to an image forming apparatus, a control method thereof, and a storage medium.

### Description of the Related Art

A technology has been developed that notifies a user of information about power consumed during operation of components included in an image forming apparatus (see Japanese Patent Laid-Open No. 2011-56909).

It is difficult for a user to understand the correspondence between components included in an image forming apparatus and functions provided by the image forming apparatus. Thus, even if the user uses a certain function of the image forming apparatus and is notified of the power consumed during operation of components included in the image forming apparatus, it is difficult for the user to understand the relationship between the use of that function and the power consumed to provide that function. On this account, it is difficult to motivate the user to address the environmental issue of power consumption by simply raising the user's awareness of the environmental issue. Alternatively, if the user is aware of and addressing the environmental issue, simply further increasing that awareness is not likely to improve the user's effort to address to the environmental issue.

### SUMMARY

The present disclosure enables realization of a new mechanism that improves user effort to address to an environmental issue.

One aspect of the present disclosure provides an image forming apparatus comprising: one or more memory devices that store a set of instructions; and one or more processors that execute the set of instructions to: receive a period from a user; obtain, for each of a plurality of functions included in the image forming apparatus, power consumed to provide the function in the received period; and output the obtained power for each of the functions.

Further features of the present disclosure will become apparent from the following description of exemplary embodiments with reference to the attached drawings.

### BRIEF DESCRIPTION OF THE DRAWINGS

FIG. 1 illustrates the internal configuration of an image forming apparatus according to an embodiment.

FIG. 2 is a block diagram of the image forming apparatus according to the embodiment.

FIG. 3 is a flowchart of a procedure according to the embodiment.

FIG. 4 illustrates a screen of an operation panel according to the embodiment.

FIG. 5 illustrates a screen of the operation panel according to the embodiment.

FIG. 6 illustrates calculation expressions used to calculate power consumptions of functions, according to the embodiment.

FIG. 7 is a flowchart of a procedure according to the embodiment.

FIG. 8 illustrates a screen of the operation panel according to the embodiment.

FIG. 9 illustrates a screen of the operation panel according to the embodiment.

FIG. 10 illustrates a screen of the operation panel according to the embodiment.

FIG. 11 illustrates a screen of the operation panel according to the embodiment.

FIG. 12 is a flowchart of a procedure according to the embodiment.

FIG. 13 illustrates a screen of the operation panel according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the ease that all such features are required, and multiple such features may be combined as appropriate. Furthermore, in the attached drawings, the same reference numerals are given to the same or similar configurations, and redundant description thereof is omitted.

Note that the term “image forming apparatus” used in the present specification broadly includes apparatuses that form (record) images on recording materials (recording media), such as single-function printers, copiers, multifunction machines, and commercial printing machines. Note also that the image forming apparatus may be a system (an image forming system) that combines the main body of an image forming apparatus that forms an image on a recording material with devices, such as a sheet processing device and a sheet feeding device.

### Hardware Configuration

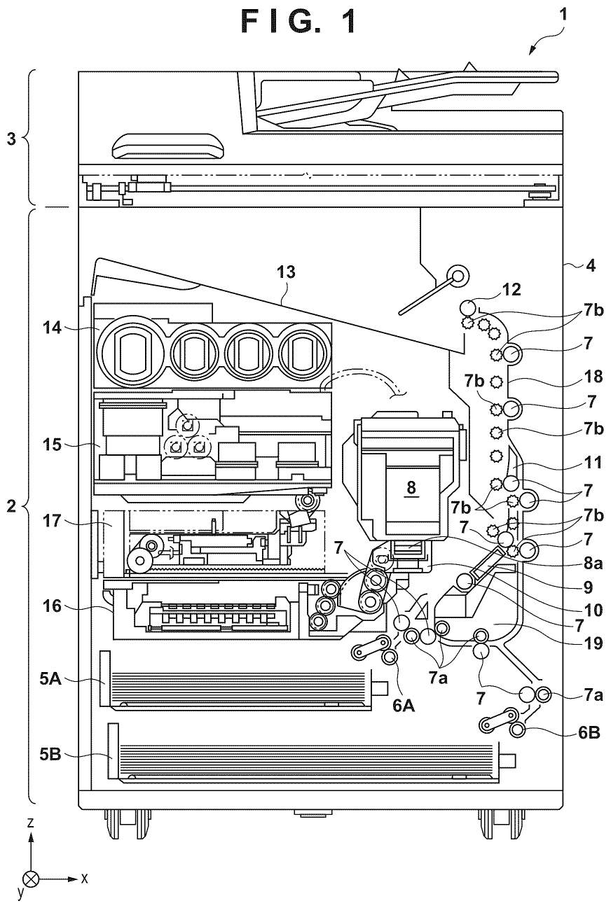

An example of the internal configuration of an image forming apparatus 1 according to the present embodiment is first described with reference to FIG. 1. Note that, in FIG. 1, the x-direction refers to the horizontal direction, the y-direction (the direction perpendicular to the plane of the paper) refers to the direction in which ejection openings of a recording head 8 described later are arranged, and the z-direction refers to the vertical direction.

The image forming apparatus 1 is a multifunction machine that includes a printing unit 2 and a scanner unit 3. More specifically, the printing unit 2 and the scanner unit 3 included in the image forming apparatus 1 are capable of executing, individually or collaboratively, various processes relating to recording and reading operations. The scanner unit 3 includes an automatic document feeder (ADF) and a flatbed scanner (FBS). The ADF reads a document that is fed automatically. The read document is placed on a platen of the FBS by the user. Then, the document placed on the platen is read (scanned). Note that although the image forming apparatus 1 is the multifunction machine that includes both the printing unit 2 and the scanner unit 3, the image forming apparatus 1 need not include the scanner unit 3.

### Block Diagram

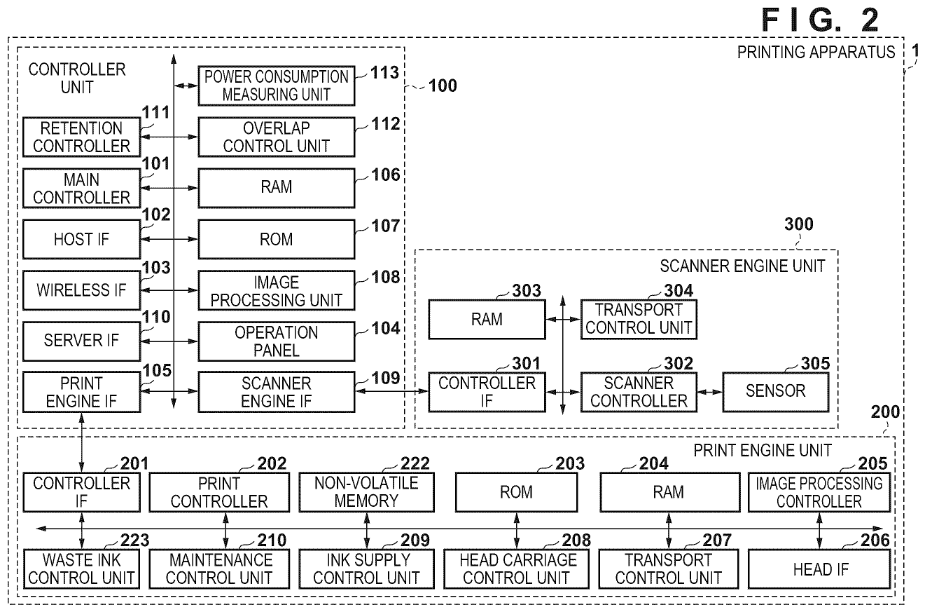

The control configuration of the image forming apparatus 1 is next described with reference to FIG. 2. The image forming apparatus 1 includes: a print engine unit 200 that mainly controls the printing unit 2; a scanner engine unit 300 that controls the scanner unit 3; and a controller unit 100 that controls the whole of the image forming apparatus 1. A print controller 202 controls mechanisms of the print engine unit 200 in accordance with instructions from a main controller 101 of the controller unit 100. Mechanisms of the scanner engine unit 300 are controlled by the main controller 101 of the controller unit 100.

### Controller Unit 100

The controller unit 100 includes the main controller 101, a RAM 106, a ROM 107, a host I/F 102, a wireless I/F 103, a server I/F 110, and an image processing unit 108.

The main controller 101 includes a CPU. In accordance with programs and various parameters stored in the ROM 107, the main controller 101 controls the whole of the image forming apparatus 1 using the RAM 106 as a work area. The host I/F 102 functions as an interface unit for connecting the image forming apparatus 1 to a host computer. The wireless I/F 103 includes a communication module and functions as an interface unit for connecting the image forming apparatus 1 to a wireless communication line. The image forming apparatus 1 can perform data communications with an external device via the wireless I/F 103 and the wireless communication line. The wireless I/F 103 is not limited to a particular type, and any type may be used.

The image processing unit 108 performs predetermined image processing. For example, a print job is received from the host computer via the host I/F 102 or the wireless I/F 103. Alternatively, a print job is received from a server via the server I/F 110. In such a case, the image processing unit 108 performs the predetermined image processing on the received image data in accordance with an instruction from the main controller 101.

The controller unit 100 further includes a print engine I/F 105. The print engine I/F 105 functions as an interface unit for connecting the controller unit 100 to the print engine unit 200. For example, the main controller 101 can transmit the image data to the print engine unit 200 via the print engine I/F 105.

The controller unit 100 further includes an operation panel 104 with a so-called touch panel display. The user can operate the image forming apparatus 1 via the operation panel 104. To be more specific, the user can execute functions of the image forming apparatus 1, such as copy and scan functions, by performing operations including touch and slide operations on a screen of the operation panel 104. Similarly, the user can also set a print mode. Moreover, the user can recognize various kinds of information about the image forming apparatus 1 that is displayed on the screen of the operation panel 104.

The controller unit 100 further includes a retention controller 111. For double-sided printing, the retention controller 111 controls the print engine I/F 105 based on whether the print engine unit 200 performs printing on the front side of a print surface or printing on the back side of the print surface.

The controller unit 100 further includes an overlap control unit 112. The overlap control unit 112 obtains blank lines of the image from the image processing unit 108. Based on a blank space at the bottom of the image on a sheet preceding a current target sheet and a blank space at the top of the image on the current target sheet, the overlap control unit 112 determines the amount of overlap between the current target sheet and the sheet preceding the current target sheet. Then, the overlap control unit 112 notifies the print engine I/F 105 of the amount of overlap. In this way, transport of two consecutive partially-overlapping sheets reduces space between the sheets, thereby increasing the processing speed.

The controller unit 100 further includes a power consumption measuring unit 113. The power consumption measuring unit 113 measures power consumption for each of portions included in the image forming apparatus 1. Furthermore, the power consumption measuring unit 113 can measure overall power consumption of the image forming apparatus 1.

### Print Engine Unit 200

The print engine unit 200 includes the print controller 202, a ROM 203, and a RAM 204. The print controller 202 includes a CPU. In accordance with programs and various parameters stored in the ROM 203, the print controller 202 controls mechanisms included in the printing unit 2 using the RAM 204 as a work area.

The print engine unit 200 further includes a controller I/F 201. The controller I/F 201 functions as an interface unit for connecting the print engine unit 200 to the controller unit 100. The print engine unit 200 further includes an image processing controller 205. The image processing controller 205 converts image data into record data. The print engine unit 200 further includes a head I/F 206. The head I/F 206 functions as an interface unit for connecting the print engine unit 200 to the recording head 8. The print engine unit 200 further includes a transport control unit 207. The transport control unit 207 performs drive control on feeding units 6A and 6B, a transport roller 7, an ejection roller 12, and a flapper 11.

Print processing is executed by these functional blocks as follows. More specifically, the print controller 202 receives data, such as various commands and image data, from the controller unit 100 via the controller I/F 201. Then, the print controller 202 stores the received data temporarily into the RAM 204. After this, the print controller 202 causes the image processing controller 205 to convert the image data included in the stored data into record data. Following the generation of the record data, the print controller 202 causes the recording head 8 to perform a recording operation based on the record data via the head I/F 206. At this time, in order to transport a recording medium S, the print controller 202 drives the feeding units 6A and 6B, the transport roller 7, the ejection roller 12, and the flapper 11 illustrated in FIG. 1 via the transport control unit 207. In this way, in accordance with the instructions from the print controller 202, the print processing is achieved through the recording operation performed by the recording head 8 in conjunction with the transport operation performed on the recording medium S.

Note that the ROM 203 stores various variables that enables settings of: a value of N in N-in-1 printing (where N is an integer); single-sided or double-sided printing; color or monochrome printing; and photograph or text printing, for example. These variables can be changed from the default settings to personalized user settings. More specifically, the print controller 202 receives a setting value entered on the operation panel 104, via the print engine I/F 105. Then, the print controller 202 stores the received setting value into the ROM 203 to reflect this setting value in print settings.

### Scanner Engine Unit 300

The scanner engine unit 300 includes a controller I/F 301, a scanner controller 302, a RAM 303, a transport control unit 304, and a sensor 305. The controller I/F 301 functions as an interface unit for connecting the scanner engine unit 300 to the controller unit 100.

In accordance with programs and various parameters stored in the ROM 107, the main controller 101 controls hardware resources of the scanner controller 302 using the RAM 106 as a work area. In this way, mechanisms included in the scanner unit 3 are controlled. The transport control unit 304 transports a document loaded in the ADF to the platen of the FBS. The sensor 305 reads information in the document placed on the platen of the FBS.

Scan processing is executed by these functional blocks as follows. More specifically, the main controller 101 controls the hardware resources of the scanner controller 302 via the controller I/F 301 so that the document loaded in the ADF by the user is transported to the platen of the FBS via the transport control unit 304. Then, the sensor 305 reads the information in the document transported onto the platen of the FBS. The scanner controller 302 stores the read information as image data into the RAM 303. Note that the image data obtained as described above is converted into record data, and thus the print controller 202 enables the recording head 8 to execute the recording operation based on the image data read by the scanner controller 302.

### Operation Example 1

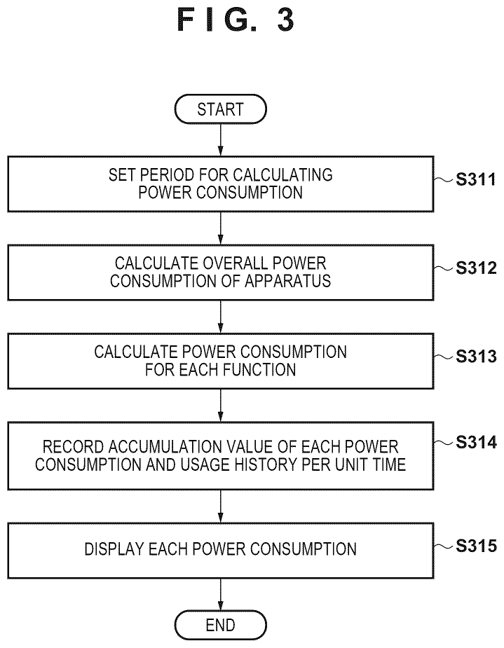

An example of the operation of the image forming apparatus 1 is described with reference to FIG. 3. The processing described below is realized by the main controller 101 reading out a program stored in the ROM 107 into the RAM 106 and then executing this program, for example.

In step S311, the main controller 101 displays, on the screen of the operation panel 104, start and end dates of a period to obtain power consumption (hereinafter, this period is also referred to as a target period). The user confirms the displayed target period. When the user wants to change the target period, the user performs a touch or slide operation on the area where the target period is displayed. Through such a screen operation, the main controller 101 receives input information from the user. Then, a new target period based on the input information is displayed on the screen. Examples of the operation performed on the screen displayed on the operation panel 104 are assumed to include an operation to make contact with the displayed screen (such as a touch, slide, drag, or swipe operation) and an operation to push a pushbutton that is not shown. Alternatively, this screen may be outputted to an external device and then an operation may be performed on this screen by using a pointing device connected to the external device.

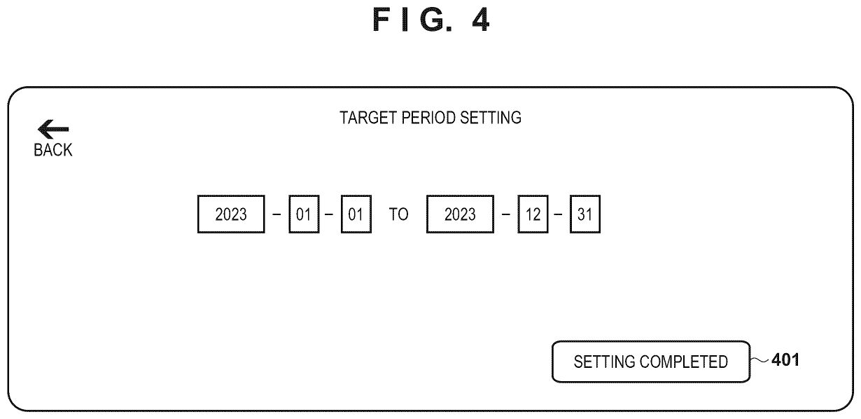

FIG. 4 illustrates an example where the start date has been changed to Jan. 1, 2023 and the end date has been changed to Dec. 31, 2023 by the screen operation performed by the user as described above. Note that the target period may be a fixed period, such as one day, one week, one month, or one year. Alternatively, either the start date or the end date may be made changeable whereas the other may be fixed.

As illustrated in FIG. 4, the main controller 101 displays an icon 401 saying “Setting completed” on the screen of the operation panel 104. After the user confirms that the target period has been changed as the user intended, the user performs an operation on the icon 401. Through such a user operation, the main controller 101 receives the setting of the target period. Note that the screen illustrated in FIG. 4 is an example of “a first setting screen”.

In step S312, the main controller 101 obtains the overall power consumption of the image forming apparatus 1 that is measured by the power consumption measuring unit 113 (an example of “a measuring unit”). Then, the main controller 101 derives a summation of the power consumption of the image forming apparatus 1.

In step S313, the main controller 101 obtains the power consumption for each of the functions of the image forming apparatus 1. Note that the functions include, for example, a print function, a copy function, a scan function, and a fax function. A method for obtaining the power consumption for each of the functions is described later.

In step S314, the main controller 101 obtains an accumulation value of the overall power consumption of the image forming apparatus 1 that is obtained in step S312 and an accumulation value of the power consumption for each of the functions that is obtained in step S313. Then, the main controller 101 stores, into the RAM 106, the obtained accumulation value of the overall power consumption of the image forming apparatus 1 and the obtained accumulation value of the power consumption for each of the functions. Moreover, the main controller 101 stores, into the RAM 106, a usage history of the image forming apparatus 1 by the user per unit time. Note that the unit time is one day, for example.

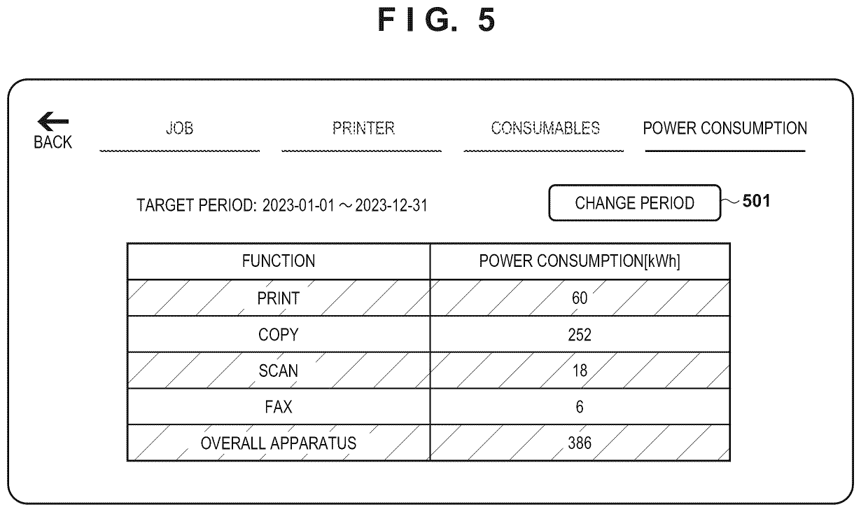

In step S315, the main controller 101 obtains the overall power consumption of the image forming apparatus 1 and the power consumption for each of the functions in the target period set in step S311, and displays (an example of “to output”) the obtained power consumptions on the screen of the operation panel 104 (see FIG. 5, for example). Note that the main controller 101 is an example of “an obtaining unit”, and that the power consumption for each of the functions is an example of “power consumed”.

The screen (an example of “a display screen”) illustrated in FIG. 5 displays tabs for Job, Printer, Consumables, and Power Consumption. In response to an operation performed on the Job tab, a job being processed by the image forming apparatus 1 is displayed. In response to an operation performed on the Printer tab, a status, such as an error occurring to the image forming apparatus 1, is displayed for example. In response to an operation performed on the Consumables tab, remaining amounts of consumables provided in the image forming apparatus 1, such as ink and media, are displayed for example.

In response to an operation performed on the Power Consumption tab, information on the power consumption of the image forming apparatus 1 is displayed. To be more specific, the screen displays, in list form, the overall power consumption of the image forming apparatus 1 and the power consumption for each of the print, copy, scan, and fax functions. Note that this screen also displays an icon 501 saying “Change period”. In response to an operation performed on the icon 501, the main controller 101 causes a transition from the image illustrated in FIG. 5 to the image for setting the target period as illustrated in FIG. 4. This allows the user to change the period to obtain the power consumption.

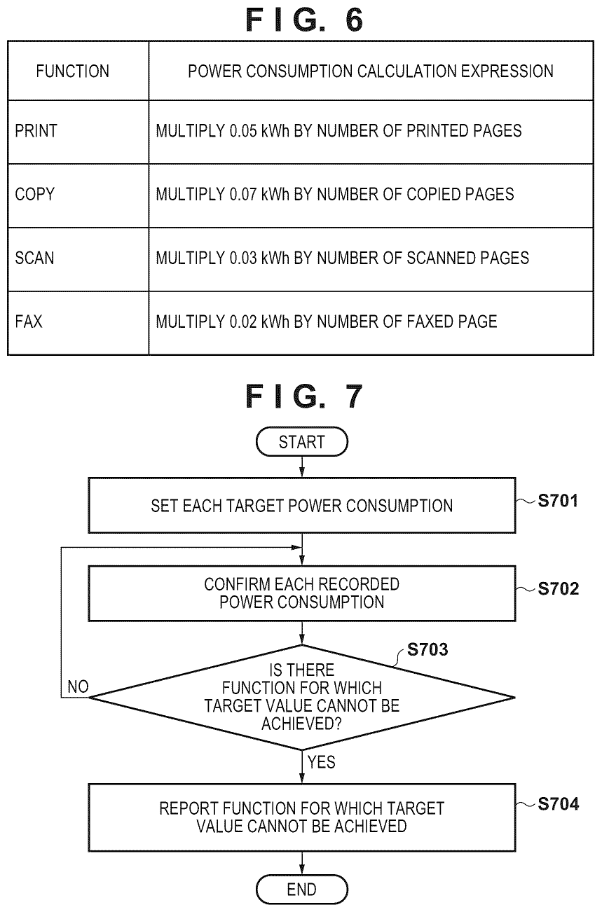

FIG. 6 illustrates an example of calculation expressions used in step S313 to obtain the power consumptions of the functions. The power consumed to provide the print function is obtained by multiplying 0.05 kWh by the number of printed pages. The power consumed to provide the copy function is obtained by multiplying 0.07 kWh by the number of copied pages. The power consumed to provide the scan function is obtained by multiplying 0.03 kWh by the number of scanned pages. The power consumed to provide the fax function is obtained by multiplying 0.02 kWh by the number of faxed pages.

### Operation Example 2

Another example of the operation of the image forming apparatus 1 is described with reference to FIG. 7. The processing described below is realized by the main controller 101 reading out a program stored in the ROM 107 into the RAM 106 and then executing this program, for example.

In step S701, the main controller 101 displays, on the screen of the operation panel 104, setting information on the target period and setting information on target values of power consumptions (hereinafter, these values are also referred to simply as the target values).

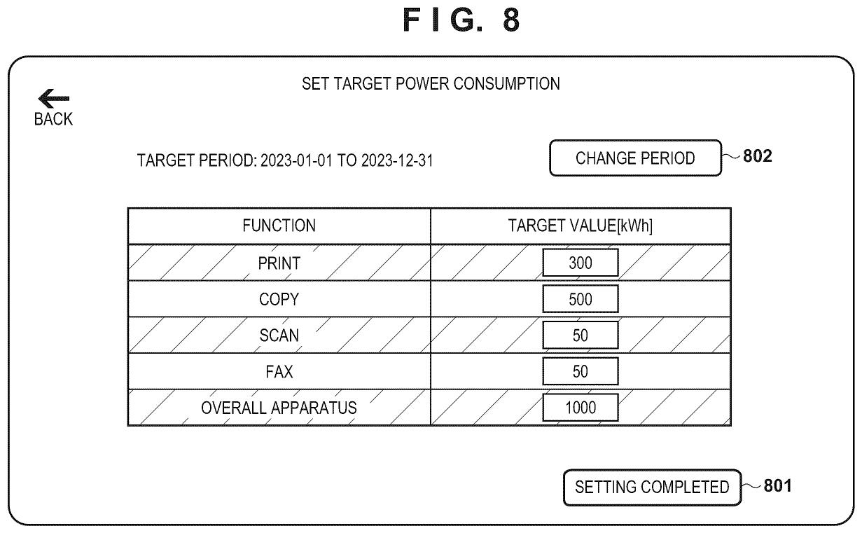

FIG. 8 illustrates an example of the screen displayed as described above (an example of “a second setting screen”). The screen displays, in list form, the target value (an example of “a first target value”) for each of the print, copy, scan, and fax functions and the target value (an example of “a second target value”) of the whole of the image forming apparatus 1.

The user confirms the displayed target values. When the user wants to change a target value, the user performs a touch or slide operation on the area of the screen where the target value is displayed. Through such a screen operation, the main controller 101 receives input information from the user. Then, a new target value based on the input information is displayed on the screen.

The main controller 101 displays the start and end dates of the period to obtain the power consumption, on the screen illustrated in FIG. 8. These start and end dates have been set in step S311. Furthermore, an icon 802 saying “Change period” is displayed on this screen. In response to an operation performed on the icon 802, the main controller 101 causes a transition from the screen illustrated in FIG. 8 to the screen illustrated in FIG. 4. This allows the user to change the period to obtain the power consumption.

Furthermore, an icon 801 saying “Setting completed” is displayed on the screen illustrated in FIG. 8. As a result of an operation performed on the icon 801, the main controller 101 receives, as the setting values, the target values and the target period to obtain the power consumption as displayed on the screen.

In step S702, the main controller 101 obtains, from the RAM 106, the power consumption for each of the functions and the overall power consumption of the image forming apparatus 1 in the target period set in step S311.

In step S703, the main controller 101 (an example of “a determining unit”) compares the target values set in step S701 with the respective power consumptions obtained in step S702, and determines whether items include an item unable to achieve the target value. Here, “to achieve the target value” indicates that the power consumption in the target period is smaller than or equal to the target value. The items referred to here are the functions and the whole of the image forming apparatus 1.

If the main controller 101 has determined that the items do not include the item unable to achieve the target value, the main controller 101 returns to step S702 and continues the processing. In contrast, if controller 101 has determined that the items include the item unable to achieve the target value, the main controller 101 displays the item unable to achieve the target value on the screen of the operation panel 104 in step S704. Note that a method for determining in step S703 whether the items include the item unable to achieve the target value is described later.

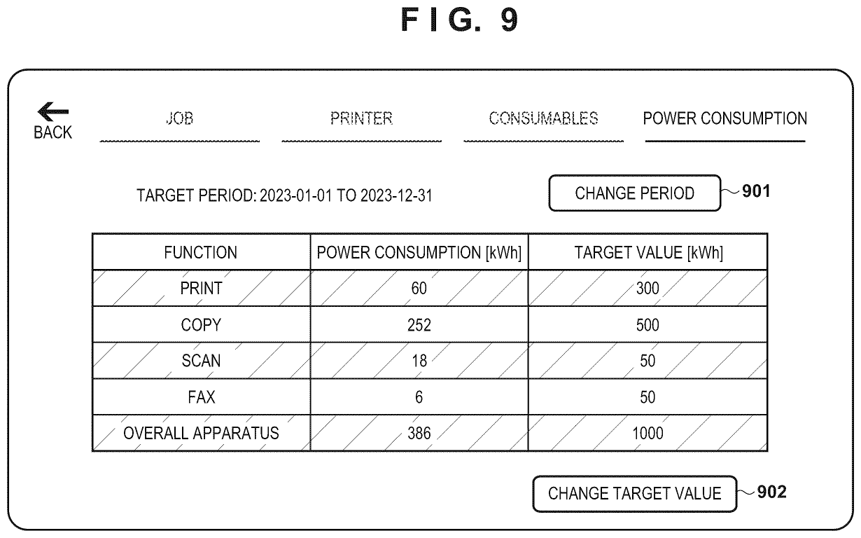

FIG. 9 illustrates an example of the screen of the operation panel 104 (an example of “a display screen”) displayed if the main controller 101 has determined in step S703 that the items do not include the item unable to achieve the target value and also the target period has ended. The main controller 101 obtains the overall power consumption of the image forming apparatus 1 and the power consumption for each of the print, copy, scan, and fax functions in the target period, and then displays the obtained power consumptions on the screen of the operation panel 104. Furthermore, the main controller 101 displays the target values corresponding to the respective power consumptions on the screen of the operation panel 104.

As illustrated in FIG. 9, the main controller 101 also displays the target period and an icon 901 saying “Change period” on the screen. In response to an operation performed on the icon 901, the main controller 101 causes a transition from this screen to the screen for setting the target period as illustrated in FIG. 4. This screen transition allows the user to change the target period.

As illustrated in FIG. 9, the main controller 101 also displays an icon 902 saying “Change target value” on the screen. In response to an operation performed on the icon 902, the main controller 101 causes a transition from this screen to the screen for setting the target values as illustrated in FIG. 8. This screen transition allows the user to change the target values.

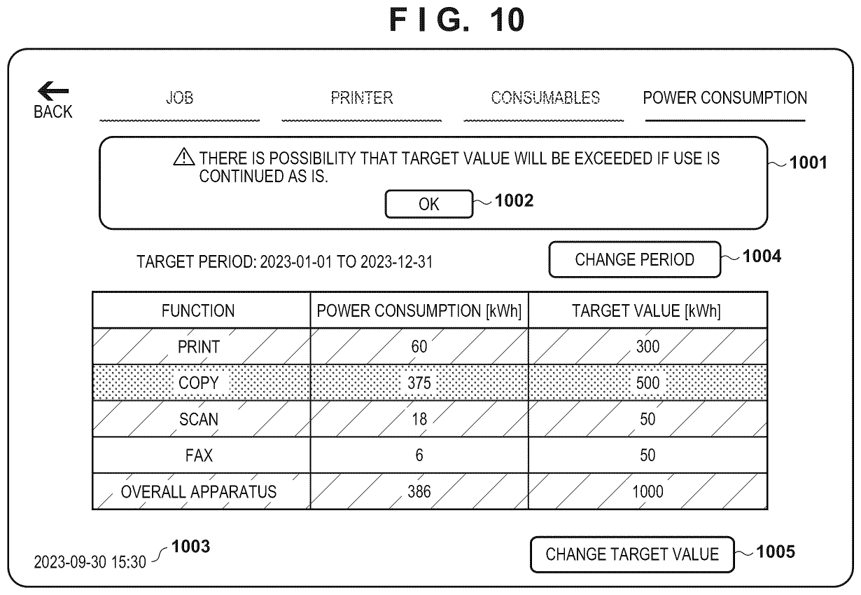

Next, the method for determining in step S703 whether the items include the item unable to achieve the target value is described in detail. More specifically, if the main controller 101 has determined that the power consumption to provide the function is predicted to exceed the target value during the target period in the future although the power consumed up to the present moment has not exceeded the target value, the main controller 101 determines that the items include the item unable to achieve the target value. FIG. 10 illustrates an example of the screen of the operation panel 104 (an example of “a display screen”) displayed in this case.

The main controller 101 displays a warning dialog 1001 that warns that the power consumption to provide the copy function will exceed the target value. Note that the main controller 101 displays an icon 1002 saying “OK” in the warning dialog 1001. In response to an operation performed on the icon 1002, the warning dialog 1001 is dismissed.

Furthermore, the main controller 101 displays distinguishably the area containing the power consumption and the target value of the copy function in a color different from colors of the other areas (an example of “to display distinguishably on the display screen”).

As in the screen illustrated in FIG. 9, the main controller 101 also displays the target period, an icon 1004 saying “Change period”, and an icon 1005 saying “Change target value”. Operations performed on the icon 1004 and the icon 1005 enable changes of the target period and the target value. Furthermore, the main controller 101 displays information 1003 indicating the current date and time.

The following describes in detail a method used by the main controller 101 to make the prediction described above. Assume that the target value of the copy function is 500 kWh, for example, and that the power consumed up to the present moment to provide the copy function is 375 kWh. Assume also that the target period is 365 days from Jan. 1, 2023 to Dec. 31, 2023, and that the current date is Sep. 30, 2023.

A period that has elapsed so far out of the target period is 273 days from Jan. 1, 2023 to Sep. 30, 2023. The main controller 101 calculates a percentage of the elapsed period in relation to the target period. This allows the main controller 101 to make a prediction, assuming that the image forming apparatus 1 continues to be used as frequently as it has been until the end of the target period.

To be more specific, assume that the target period is represented by D1, the period that has elapsed so far out of the target period is represented by D2, the target value is represented by W1, and the power consumption is represented by W2. If (D2/D1)×W1 is greater than W2, the main controller 101 predicts that the power consumptions of the items do not exceed the respective target values if the image forming apparatus 1 continues to be used as frequently as it has been. In contrast, if (D2/D1)×W1 is smaller than or equal to W2, the main controller 101 predicts that the power consumptions of the items exceed the respective target values if the image forming apparatus 1 continues to be used as frequently as it has been.

For example, the power consumed to provide the copy function and the corresponding target value shown in FIG. 10 are substituted into this calculation expression, where D1=365, D2=273, W1=500, and W2=375. As a result, (273/365)×500=373.97 . . . <375. Thus, the main controller 101 determines that the power consumed to provide the copy function exceeds the target value and then displays the warning dialog 1001.

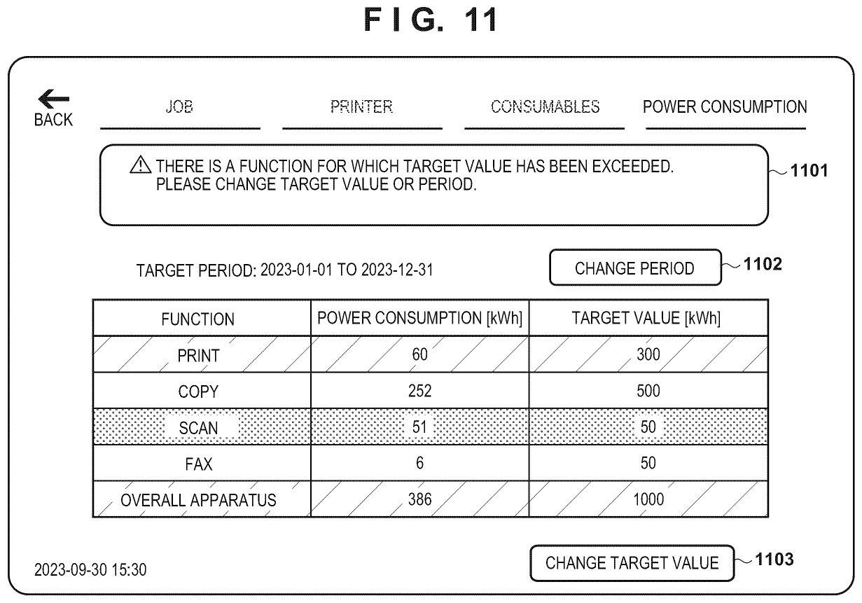

Alternatively, if the power consumed up to the present moment within the target period to provide the function has exceeded the target value, the main controller 101 determines that the items include the item unable to achieve the target value. FIG. 11 illustrates an example of the screen of the operation panel 104 displayed in this case.

The screen (an example of “a display screen”) illustrated in FIG. 11 is different from the screen illustrated in FIG. 10 mainly in the following aspect. More specifically, the main controller 101 displays an error dialog 1101 notifying that the power consumed to provide the scan function has exceeded the target value during a period from the start date of the target period to the present moment. Furthermore, the main controller 101 displays distinguishably the area containing the power consumption and the target value of the scan function in a color different from colors of the other areas (an example of “to display distinguishably on the display screen”). Note that this color may be darker than the color used when the power consumption is predicted to exceed the target value in the future as illustrated in FIG. 10.

As in the screen illustrated in FIG. 9, the main controller 101 also displays the target period, an icon 1102 saying “Change period”, and an icon 1103 saying “Change target value”. Operations performed on the icon 1102 and the icon 1103 enable changes of the target period and the target value.

The following describes in detail a method used by the main controller 101 to make the determination in step S703. More specifically, if the target value W1 and the power consumption W2 in the target period satisfy W1>W2, this indicates that the power consumption of the corresponding item of the image forming apparatus 1 has not reached the target value. Thus, the main controller 101 determines that the power consumed up to the present moment to provide the function has not exceeded the target value. In contrast, if W1 is smaller than or equal to W2, this indicates that the power consumption of the corresponding item of the image forming apparatus 1 has reached the target value. Thus, the main controller 101 determines that the power consumed up to the present moment to provide the function has exceeded the target value. For example, the power consumed to provide the scan function and the corresponding target value shown in FIG. 11 are substituted into this calculation expression, where W1=50 and W2=51. As a result, 50<51. Thus, the main controller 101 determines that the power consumed to provide the scan function has exceeded the target value.

### Operation Example 3

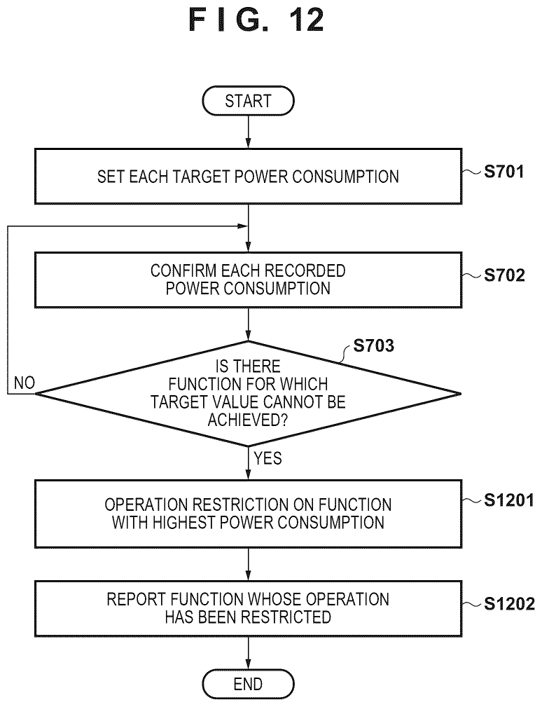

Another example of the operation of the image forming apparatus 1 is described with reference to FIG. 12. As illustrated in FIG. 12, steps S701 to S703 are the same as in the operation example 2.

If the main controller 101 has determined that the items include the function unable to achieve the target value in step S703, the main controller 101 restricts an operation of the function that consumes the most power in step S1201. For example, the power consumed to provide the copy function is predicted to exceed the target value in the future in the case illustrated in FIG. 10. In this case, the main controller 101 (an example of “a controlling unit”) suspends the operation of the copy function that consumes the most power among the print, copy, scan, and fax functions (an example of “to restrict the operation”).

In step S1202, the main controller 101 displays a message saying that the operation of the function that consumes the most power has been restricted, on the screen of the operation panel 104.

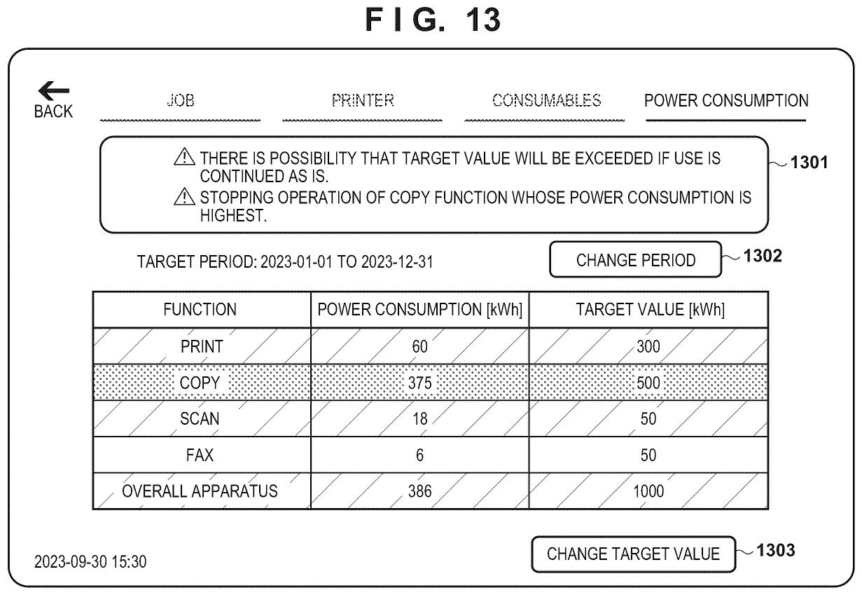

FIG. 13 illustrates an example of the screen of the operation panel 104 (an example of “a display screen”) in step S1202. For example, if the main controller 101 suspends the operation of the copy function, the main controller 101 displays an error dialog 1301 on the screen. For example, the error dialog 1301 includes: a message warning that the power consumption to provide the copy function exceeds the target value in the future; and a message saying that the operation of the copy function has been suspended. As in the screen illustrated in FIG. 10, the main controller 101 also displays an icon 1302 saying “Change period” and an icon 1303 saying “Change target value” on the screen illustrated in FIG. 13. Operations performed on the icon 1302 and the icon 1303 enable changes of the target period and the target values.

Here, if at least either the target period or the target value is changed, the suspension of the operation of the copy function may be lifted.

### Operations and Effects

The image forming apparatus 1 allows the user to easily understand, by looking at the screen of the operation panel 104 illustrated in FIG. 5, that a large amount of power has been consumed by the use of the copy function. Thus, the user awareness of power consumption as an environmental issue is raised. This motivates the user to reduce the use of the copy function. Otherwise, if the user has been reducing the use of the copy function, the user awareness can be increased and thereby improves the degree to which the user has been reducing the use of the copy function.

The user looking at the image illustrated in FIG. 4 or FIG. 5 can change the target period. If the user extends the current target period, the user awareness to reduce the use of the copy function continues to be raised over a long period. Thus, the reduction of the use of the copy function continues to improve over a long period. In contrast, if the user shortens the current target period, this allows the user to know short-term power consumption. Thus, if the power has been consumed intensively by the copy function for a certain period, such a period can be determined. This motivates the user to reduce the use of the copy function in this period.

Furthermore, the user looking at the image illustrated in FIG. 8 or FIG. 9 can change the target value. If the user lowers the current target value, the degree to which the user has been reducing the use of the copy function can be improved.

Furthermore, the user looking at the image illustrated in FIG. 10 or FIG. 11 can more easily understand that a large amount of power has been consumed by the use of the copy function (or the scan function in FIG. 11). This also motivates the user to reduce the use of the copy function without waiting for the end of the target period. Otherwise, if the user has been reducing the use of the copy function, the degree to which the user has been reducing the use of the copy function can be improved before the end of the target period.

Furthermore, the image forming apparatus 1 displaying the image illustrated in FIG. 13 forcefully motivates the user to reduce the use of the copy function without waiting for the end of the target period. Otherwise, if the user has been reducing the use of the copy function, the degree to which the user has been reducing the use of the copy function can be forcefully improved before the end of the target period.

Furthermore, the image forming apparatus 1 displaying the image illustrated in, for example, FIG. 5 allows the user to recognize the relationship of relative amounts of power consumed by the functions. This motivates the user to reduce the use of the function that consumes a relatively large amount of power. Otherwise, if the user has been reducing the use of the function that consumes the relatively large amount of power, the degree to which the user has been reducing the use of this function can be improved. Moreover, the image forming apparatus 1 allows the user to recognize a percentage of the power consumption for each of the functions in relation to the overall power consumption of the image forming apparatus 1. This makes the user aware of the function that should be used less to reduce the overall power consumption of the image forming apparatus 1.

### Variations

The present disclosure is not limited to the embodiment described above and is applicable to various variations. For example, according to the present disclosure, screen information displayed by the main controller 101 on the screen of the operation panel 104 may be transmitted to an external device (such as a mobile terminal owned by the user) of the image forming apparatus 1 via a network, and then this external device may display the screen information.

In step S312, the main controller 101 may derive the power consumption for each of the functions by reference to a correspondence table between the overall power consumption of the image forming apparatus 1 and the power consumption for each of the functions that are measured by the power consumption measuring unit 113. Alternatively, in step S312, the main controller 101 may calculate the power consumption for each of the functions from the overall power consumption of the image forming apparatus 1 that was measured.

The determination expression used in the determination method in step S703 is not intended to be limiting. Furthermore, the determination method is not limited to using the determination expression. For example, by reference to a correspondence table between power consumed up to the present moment and power to be consumed in the future, the future power consumption may be predicted (an example of “to obtain”). Then, whether this future power consumption exceeds the target value may be determined.

In step S1201, the operation of the copy function is suspended because the power consumption to provide the copy function is predicted to exceed the target value in the future. However, the operation of the copy function may be suspended if the power consumption to provide the copy function has exceeded the target value. Alternatively, the operation of the copy may be restricted to keep the power consumption below the target value.

Furthermore, although the common target period is set all at once for the items in the embodiment described above, the target period may be set individually for each of the items.

The image displayed on the operation panel 104 illustrated in FIG. 10 may include, for example, a symbol pointing at the area containing the power consumption and the target value of the copy function. Furthermore, the column containing the power consumption and the target value of the copy function may be displayed at the top or bottom of the list. These displays are examples of “to display distinguishably on the display screen”.

Furthermore, the screen of the operation panel 104 may display the functions and the respective power consumptions to provide these functions, without displaying the overall power consumption of the image forming apparatus 1.

In place of, or in addition to, the display of the warning dialog 1001 or the error dialog 1101 or 1301, sound or light may be used to notify the user of the warning or the error.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-090923, filed Jun. 4, 2024 which is hereby incorporated by reference herein in its entirety.

What is claimed is:

1. An image forming apparatus comprising:
one or more memory devices that store a set of instructions; and
one or more processors that execute the set of instructions to:
receive a period from a user;
obtain, for each of a plurality of functions included in the image forming apparatus, power consumed to provide the function in the received period; and
output the obtained power for each of the functions.

2. The image forming apparatus according to claim 1, wherein
the one or more processors execute instructions in the one or more memory devices to:
display, on a displaying unit, a first setting screen for setting the period; and
receive the period from the user via the first setting screen.

3. The image forming apparatus according to claim 2, wherein
the plurality of functions include a plurality of types of functions, and
the period is settable all at once as a period common to all of the plurality of functions.

4. The image forming apparatus according to claim 2, wherein
the period is settable for each of the functions.

5. The image forming apparatus according to claim 2, wherein
the one or more processors execute instructions in the one or more memory devices to:
display on the displaying unit a display screen indicating, for each of the functions, a first target value of power consumed to provide the function; and
display on the displaying unit a second setting screen for setting the first target value.

6. The image forming apparatus according to claim 5, wherein
the second setting screen includes an object to make a transition from the second setting screen to the first setting screen.

7. The image forming apparatus according to claim 5, wherein
the one or more processors execute instructions in the one or more memory devices to:
display the plurality of functions in list form on the display screen, the plurality of functions including a plurality of types of functions;
further determine whether the plurality of functions include a function unable to achieve the first target value in the period; and
in a case of a determination that the plurality of functions to include the function unable to achieve the first target value in the period, display distinguishably on the display screen that the plurality of functions include the function unable to achieve the first target value in the period.

8. The image forming apparatus according to claim 7, wherein
the one or more processors execute instructions in the one or more memory devices to:
in a case where the plurality of functions include a function consuming power that exceeds the first target value during the period, determine that the plurality of functions include the function unable to achieve the first target value in the period.

9. The image forming apparatus according to claim 7, wherein
the one or more processors execute instructions in the one or more memory devices to:
predict future power consumption in the period, based on the power; and
in a case where the plurality of functions include a function for which the future power consumption was predicted to exceed the first target value, determine that the plurality of functions include the function unable to achieve the first target value in the period.

10. The image forming apparatus according to claim 7, wherein
the one or more processors execute instructions in the one or more memory devices to:
further control operation of portions that provide the functions;
in a case where the plurality of functions include the function unable to achieve the first target value in the period, restrict operation of a portion that provides the function unable to achieve the first target value in the period; and
output the display screen further indicating that operation of the restricted portion has been restricted.

11. The image forming apparatus according to claim 5, wherein
the one or more processors execute instructions in the one or more memory devices to:
further obtain a summation of power consumption of the image forming apparatus; and
output the display screen further indicating the summation and a second target value of the summation of the power consumption of the image forming apparatus.

12. The image forming apparatus according to claim 1, wherein
the one or more processors execute instructions in the one or more memory devices to:
further measure power consumption of the image forming apparatus; and
calculate the power consumed for each of the functions, by using the measured power consumption.

13. The image forming apparatus according to claim 1, wherein
the one or more processors execute instructions in the one or more memory devices to:
further measure power consumption of the image forming apparatus; and
obtain the power consumed for each of the functions by reference to a correspondence table between the measured power consumption and the power consumed for each of the functions.

14. A control method of an image forming apparatus, the control method comprising:
receiving a period from a user;
obtaining, for each of a plurality of functions included in the image forming apparatus, power consumed to provide the function in the received period; and
outputting the obtained power for each of the functions.

15. A non-transitory computer-readable storage medium storing a computer program for causing a computer to execute a control method of an image forming apparatus, the control method comprising:
receiving a period from a user;
obtaining, for each of a plurality of functions included in the image forming apparatus, power consumed to provide the function in the received period; and
outputting the obtained power for each of the functions.
